(19) United States
(12) Patent Application Publication
(10) Pub. No.: US 2021/0095175 A1
(43) Pub. Date: Apr. 1, 2021

(54) ENVIRONMENT-FRIENDLY SNOW REMOVAL AGENT USING COMPONENT OF STARFISH

(71) Applicant: Ryan Joongi Cho, Seoul (KR)

(72) Inventor: Ryan Joongi Cho, Seoul (KR)

(21) Appl. No.: 17/013,553

(22) Filed: Sep. 5, 2020

(30) Foreign Application Priority Data
Sep. 27, 2019 (KR) 10-2019-0119230

(51) Int. Cl. C09K 3/18

(52) U.S. Cl. CPC C09K 3/185

(57) ABSTRACT

A new snow removal agent, which is developed in the present invention, has about 70% snow removal ability compared to that of calcium chloride (CaCl2). Therefore, as experimental materials, magnesium chloride (MgCl2), citric acid, sodium carbonate (Na2CO3), and sodium acetate (CH3COONa) were mixed in a certain ratio in rock salt, and then the new environment-friendly snow removal agent was made through a multi-step experimental procedure. It has already been confirmed through the experiments that it is a snow removal agent which is very excellent in terms of performance and environmental friendliness compared to the snow removal agent currently available in the market.

### TECHNICAL FIELD

The present invention relates to an environment-friendly snow removal agent, and more specifically, to an environment-friendly snow removal agent to remove snow in winter using component of starfish.

### BACKGROUND

In order to remove snow falling on roads in winter, snow removal agents widely used around the world are chloride-based snow removal agents such as sodium chloride (NaCl) and calcium chloride (CaCl2). However, these snow removal agents contain a large amount of chlorine ions (Cl), which causes severe corrosion and environmental pollution when a large amount of the snow removal agents sprays. If chloride dissolves in water and flows into rivers or lakes, it can cause destruction of aquatic ecosystems and contamination of drinking water. In addition, chloride may affect growth of street trees and plants around roads, and may affect a formation of terrestrial clusters. Chloride caused by the snow removal agents directly comes into contact with plants in a form of dust in the atmosphere or melts into the soil, thereby being absorbed by the roots of plants to affect the growth of the plants. Calcium chloride (CaCl2) concentrated in the soil comes into contact with the roots of the plant and causes general growth disorder, mortality of specific parts such as branches, and the like, and in a severe case, death of the plant itself. In particular, due to a lot of snowfall in winter caused by the recent abnormal climate, a large amount of calcium chloride (CaCl2) for snow removal is used, and the used calcium chloride (CaCl2) permeates the planting of street trees around roads in urban areas, thereby increasing the pH of the soil. Therefore, it not only interferes the absorption of nutrients, but also kills mycorrhizal microorganism, so that a damage caused by plant death can be increased because the roots are not nourished. In addition, in a case where calcium chloride (CaCl2) is scattered and directly comes into contact with the leaves of the plant, the plant itself may eventually die by inhibiting photosynthesis by drying the leaves. Due to the use of chloride-based snow removal agents, trees (street trees) are extremely damaged and the aesthetics of the city center is degraded, as well as a huge budget is being spent on restoration costs. However, in the related art, as a follow-up measure after using the chloride-based snow removal agent, a method for mixing a soil conditioner containing sulfur to reform the acidity of the soil, a method for replacing soil and transporting soil, that is, removing the topsoil and replacing with fresh soil, or a method for mixing fresh new soil with the soil of the existing topsoil layer is mainly used. Meanwhile, most of the methods are spraying a transpiration inhibitor on the leaves of trees or mixing activated carbon to remove residual calcium chloride (CaCl2) from the soil. As the related art to prevent the damage from the chloride-based snow removal agents such as calcium chloride (CaCl2), there are Korean Patent Registration No. 10-0985947 (Apparatus for Protection of Street Tree), Korean Utility Model Registration No. 20-0444747 (Fence for Preventing Spray of Snow Removal Solution), and the like.

The principle of using calcium chloride is that when the crystal thereof is mixed with water, an exothermic reaction occurs thereby melting snow. As snow accumulates, it melts to some extent due to temperature or pressure, and the melted water and calcium chloride react exothermically to release heat. The heat melts the surrounding snow thereby making water, and the water reacts with calcium chloride again and continues to melt the snow. Calcium chloride not only melts the snow, but also prevents the melted snow from freezing. An effect, in which water without impurities freezes at 0° C., but water mixed with other substances freezes at temperatures lower than 0° C., is scientifically called a total property. It is a property that is not affected by a chemical composition or any ion, but only depends on the total number of ions dissolved in the solution. Therefore, when developing the snow removal agent, in order to achieve an effect of lowering a freezing point, it is possible to easily predict how much the freezing point will go down by calculating the number of metal or non-metal ions which can be dissolved in certain water.

Water in which 30% of calcium chloride is mixed starts to freeze only when it reaches −50° C.

Calcium chloride is effective to prevent the road from being frozen on a cold winter night when the temperature goes down. However, calcium chloride is highly corrosive and has disadvantages such as damaging an automobile or a reinforcing rebar in concrete, and killing small trees around roads. In addition, it has an excellent ability to absorb moisture, and it absorbs moisture in the air even after the snow has melted, thereby making the road muddy.

For such a reason, salt is mainly used as the snow removal agent in the United States, Japan, Germany, and Canada. In an experiment conducted by the National Research Council of Canada, calcium chloride outperformed the snow removal capacity below −10° C., but salt was more effective between 0° C. and −10° C.

In addition, salt has a corrosive property of about 70% of that of calcium chloride, so that it is more useful in terms of environment, and the price is cheap. However, a biggest role of the snow removal agent is to melt snow, and the temperature changes from time to time when it snows, and thereby a method for using a mixture of calcium chloride and salt, whose snow removal capacity varies depending on the temperature, is emerging as a most effective method. Usually, calcium chloride and salt are used in a ratio of about 1:3, and at a low temperature, a lot of calcium chloride is added and calcium chloride and salt are mixed in a ratio of 1:1 to increase the effect of snow removal.

Since the present invention is focused on, ‘environmental friendliness of calcium chloride’, an object of the present invention is to provide an environment-friendly snow removal agent and a method for manufacturing the same, in which a corrosion damage of metal due to the use of calcium chloride in winter can be suppressed, the snow removal agent can be safely stored without being hardened for a long period of time, no re-freezing occurs, yellowing and death of plants are greatly reduced, and the environment-friendly snow removal agent is useful for plant growth. Therefore, considering the chemical and environmental factors for the object, the present invention is made to develop the environment-friendly snow removal agent that can optimize the both factors.

### SUMMARY

The present invention grasps problems of an existing environment-friendly snow removal agent that does not have significant advantages in an actual environment by replacing only calcium chloride having proven hazard or calcium chloride with another chlorine-based snow removal agent that is an environment-friendly snow removal agent, and an object of the present invention is to develop an environment-friendly and low-corrosive snow removal agent that has a non-chlorine-based melting effect.

In order to develop a composition of the environment-friendly snow removal agent, since it requires a best formulation that does not harm a snow removal ability or the environment through an appropriate combination of compounds having various chemical properties, there is a need for significant magnification combination tests for this.

Since ice has already formed, it is a process that requires physical and chemical measures. It has no effect below −18° C. As an experiment in this process, after spraying several snow removal agents indoors on an ice plate, a melting state and a friction force between the ice surface and an object were measured. A best melting process is a physically solving method, but if there is no snowplow, the chemical snow removal agent is minimally used.

### ADVANTAGEOUS EFFECTS

First, since re-freezing does not occur after spraying the snow removal agent, there are advantages that the cost of re-spraying the snow removal agent can be reduced, and the risk of accidents can be prevented.

Second, it is environmentally friendly because it does not have a harmful effect on plants or fish and shellfish in the experiment through the experiment.

Third, even when the snow removal agent is stored for long period of time, the snow removal agent does not harden.

Fourth, it is possible to suppress the corrosion damage of metal such as a steel structure, an automobile, or a building.

Fifth, it is possible to prevent a problem that may cause cracks in the road due to melting heat having a high temperature.

### BRIEF DESCRIPTION OF THE DRAWINGS

FIG. 1 is a view illustrating to an environment-friendly snow removal agent using component of starfish according to an embodiment of the present invention.

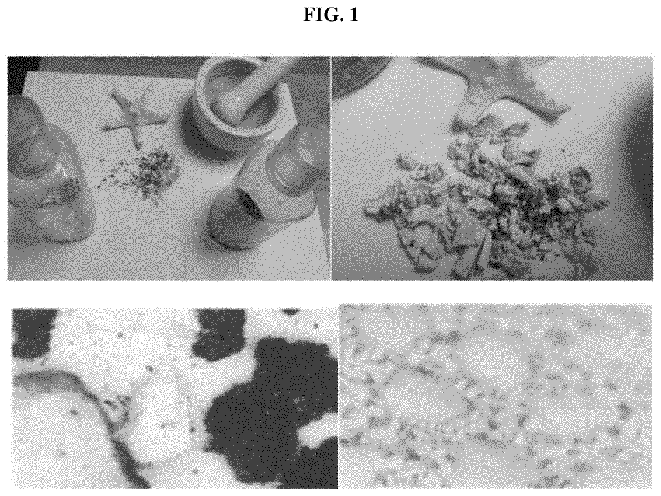

### DETAILED DESCRIPTION OF THE DISCLOSURE

A new snow removal agent, which is developed in the present invention based on the environment-friendly snow removal agent used as a material for snow removal agent in advanced countries, has about 70% snow removal ability compared to that of calcium chloride (CaCl2). Therefore, as experimental materials, magnesium chloride (MgCl2), citric acid, sodium carbonate (Na2CO3), and sodium acetate (CH3COONa) were mixed in a certain ratio in rock salt, and then the new environment-friendly snow removal agent was made through a multi-step experimental procedure. It has already been confirmed through the experiments that it is a snow removal agent which is very excellent in terms of performance and environmental friendliness compared to the snow removal agent currently available in the market.

The ratio used in the environment-friendly snow removal agent developed in the present invention is as follows.

Rock salt NaCl 20%, magnesium chloride MgCl2 20%, sodium carbonate Na2CO3 20%,

Citric acid 30%, sodium acetate CH3COONa 10%

If the ratio of the above compositions is adjusted little by little, new environment-friendly snow removal agents that can obtain optimal effects in terms of performance and cost can be divided into several types and produced.

The reason for using magnesium chloride (MgCl2) in the present invention is to overcome the problem of calcium chloride (CaCl2) which is a main raw material of the existing snow removal agent. Although magnesium chloride (MgCl2) has a slightly lower thawing effect than that of calcium chloride (CaCl2), it is safe because it does not cause cracks on the road, and if it is mixed with rock salt and dried by hot air, metal corrosion resistance can be improved and hardening thereof can be prevented when the snow removal agent is stored for long period of time.

What is claimed is:

1. An environment-friendly snow removal agent comprising starfish ingredient, calcium chloride (CaCl2), rock salt (NaCl), magnesium chloride (MgCl2), ammonium chloride (NH4Cl), sodium carbonate (NaCO3), sodium acetate (CHXOONa), and sodium phosphate (Na5P5010)

2. The environment-friendly snow removal agent of claim 1, wherein the environment-friendly snow removal agent is obtained by mixing NaCl 20%, MgCl2 20%, Na2CO3 20%, citric acid 30%, and sodium acetate 10%.
